(19) United States
(12) Patent Application Publication
(10) Pub. No.: US 2018/0274480 A1
(43) Pub. Date: Sep. 27, 2018

(54) Two-Part Piston Having an Open Cooling Channel

(71) Applicant: KS Kolbenschmidt GmbH, Neckarsulm (DE)

(72) Inventor: Klaus Lormes, Bad Wimpfen (DE)

(21) Appl. No.: 15/763,998

(22) PCT Filed: Oct. 4, 2016
(86) PCT No.: PCT/EP2016/001633

§ 371 Date: Mar. 28, 2018

(30) Foreign Application Priority Data
Oct. 1, 2015 (DE) 102015219050.1

(51) Int. Cl. F02F 3/22; F02F 3/00

(52) U.S. Cl. CPC F02F 3/22; F02F 2003/0061; F02F 3/003

(57) ABSTRACT

An internal combustion engine piston formed by a lower part connected to an upper part through a form-fitting connection. In one example, the piston lower part has a flat joining area with at least one recess and the piston upper part has a flat joining area including an annular recess. The upper part annual recess extends from the joining area into the lower part, wherein the at least one recess of the lower part is in overlap with a partial area of the annular recess in the upper part after the form-fitting connection. In one example, a sealing element is used between the upper part and the lower part.

### TECHNICAL FIELD

The invention relates to a piston for internal combustion engines.

### BACKGROUND

Up to now, the weight optimization in the case of two-part pistons with an open cooling passage has been carried out by local weight savings accompanied by increasing cost disadvantage.

### SUMMARY

The invention is based on the object of specifying a piston with optimized mass, by means of which the disadvantages which are described in the introduction are avoided.

The object is achieved by the bottom part having a flat joint region with at least one recess and the top part having a flat joint region and also having an annular recess which extends from the joint region into the bottom part, wherein the at least one recess of the bottom part is in overlapping alignment with a section of the annular recess after the materially bonding connection. Created as a result of the annular recess in the top part is a space which during operation of the piston forms a cooling passage which, with regard to the piston stroke axis, is open toward the bottom or can be closed off by a sealing element. By the separate production of the top part in a suitable manner (such as casting, forging or the like) the desired contouring of the subsequent cooling passage can be achieved. The introduction of the annular recess is also carried out during the forging if the top part is produced by forging, but can also be introduced by further machining, such as by metal cutting machining. Both during the forging and during the casting of the top part any contouring, such as uniform cross sections or cross sections which deviate from each other, with or without undercuts, over the annular extent are possible. At the same time, adjacently lying joint regions (such joint regions which are subsequently in the direction of the ring zone of the piston and such joint regions which are subsequently in the direction of the piston stroke axis in this case) are realized together with the production or introduction of the annular recess in the bottom part. Via these joint surfaces (joint regions), the top part can be connected to the bottom part in a suitable manner.

Produced separately from the top part is a bottom part, also in a suitable manner, such as by forging, casting or a combination of such methods including the subsequent attaching of piston elements on a piston base part, such as welding of piston skirts onto a piston base part. During the production, or subsequent to it, the bottom part is provided with the at least one recess, wherein a joint region is also formed around the at least one recess. As a result, specific contours for the materially bonding connection can be dispensed with both in the top part and in the bottom part. Above all, circumferentially encompassing flanges with joint surfaces on the bottom part and on the top part, as are known from the prior art, are dispensed with. In other words, both the bottom part and the top part are produced, having a large-area joint region for the materially bonding connection, of which only the annular recess in the top part and the at least one recess in the bottom part are excluded. As a result of this large-area joint region, the overall stability of the finished piston after the materially bonding connecting of top part to bottom part is increased. Furthermore, a very high degree of flexibility exists in the contouring not only of the annular recess of the top part (as already described above) but also during the introduction of the at least one recess in the bottom part, which can also be carried out by metal cutting machining (such as milling of the like) or forging. Especially when the annular recess in the top part is used as a cooling passage (open or closed), the at least one recess in the bottom part provides an appreciable material saving.

In a development of the invention, provision is made in the bottom part for more than two recesses, preferably for four recesses. These at least two recesses are also in overlapping alignment with the annular recess of the top part so that as a result of a plurality of recesses in the bottom part more material can be saved and the weight of the finished piston can be reduced. Furthermore, as a result of the at least two recesses, or more than two recesses, it is possible to inject cooling medium into the cooling passage of the annular recess in the top part. Especially when the at least two recesses in the bottom part extend over a larger circular arc section of the annular cooling passage (and are therefore not formed as a round recess), a high volume of cooling medium can be injected, wherein at the same time tolerances are compensated during the installation of the injection nozzle for the cooling medium since a larger impingement surface is made available for the cooling oil jet which is delivered by the injection nozzle.

In a development of the invention, a sealing element is inserted between the bottom part and the top part. Such a one-piece or multi-piece sealing element can be produced separately from the bottom part and the top part and then be inserted when the top part is connected in a materially bonding manner to the bottom part. During this materially bonding connecting, the fastening of the sealing element on the bottom part and/or on the top part can be carried out at the same time. The one-piece or multi-piece sealing element creates a naturally sealed space in the top part by covering the annular recess so that during subsequent operation of the finished piston this space serves as an annular cooling passage. So that a cooling medium can be introduced in this space and also discharged again or circulated it is still necessary to introduce at least one inlet opening and one outlet opening. These can be introduced into the bottom part and/or the top part and/or the sealing element at a suitable point, depending on the geometry of the finished piston. It is important that a cooling oil jet of an injection nozzle can be injected via the at least one inlet opening into the annular cooling passage in the top part, so the injected cooling oil can then circulate in the annular cooling passage and can then be discharged again via the at least one outlet opening.

In a development of the invention, the sealing element has at least one opening, preferably two openings. The at least one opening serves as an inlet opening and outlet opening so that via the at least one recess in the top part the cooling oil jet can be injected into the annular recess of the top part via the at least one opening in the sealing element. So that the cooling medium can circulate in the cooling passage in the top part, it is advantageous if the sealing element has two openings, wherein the one opening (e.g. a drilling) serves as the inlet opening and the other opening (e.g. also a drilling) serves as the outlet opening. In this case, it is self-evident that these two openings of the sealing element are arranged in those regions of the at least one recess in the top part or in recesses of the bottom part which differ from each other.

For the materially bonding connection, a friction weld joint may be particularly advantageously considered since the flat joint regions facing each other on the bottom part or on the top part are particularly well suited for this. The friction weld beads which are created during the friction welding process can be removed altogether or partially removed or not removed at all. If they are not removed at all, this depends on whether they are generally accessible (if they are not accessible, removal is not possible) or whether they interfere with the operation of the piston or, for example, interfere with the flow of the cooling medium.

An exemplary embodiment of a piston without a sealing element, and an exemplary embodiment of a piston with a sealing element are described in the following text and are explained in more detail with reference to the drawings.

### BRIEF DESCRIPTION OF THE DRAWINGS

FIG. 1A is a bottom perspective view of a bottom part of a piston;

FIG. 1B is top perspective view of the bottom part of the piston in FIG. 1A;

FIG. 2A is a top perspective view of a top part of a piston;

FIG. 2B is a bottom perspective view of the top part of the piston in FIG. 2A;

FIG. 2C is a cross-sectional view taken along line C-C in FIG. 2A;

FIG. 3A is a frontal perspective view of a finished piston;

FIG. 3B is a cross-sectional view taken along line 3B-3B in FIG. 3A;

FIG. 4A is an alternate bottom perspective view of the piston shown in FIG. 3A;

FIG. 4B is a cross-sectional view taken along line 4B-4B in FIG. 4A;

FIG. 4C is a cross-sectional view taken along line 4C-4C in FIG. 4A;

FIG. 5A is bottom perspective view of an alternate example of a piston;

FIG. 5B is a top perspective view of an example of a sealing element;

FIG. 5C is a cross sectional view taken along line 5C-5C in FIG. 5A;

FIG. 6A is a top perspective view of an alternate example of a sealing element; and

FIG. 6B is a bottom view of an alternate example of a piston.

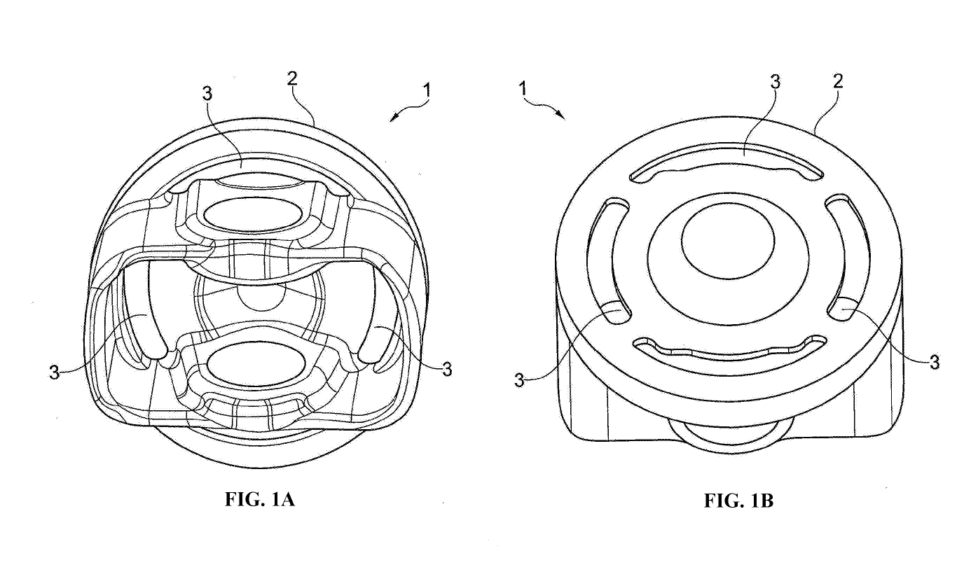

FIG. 1 shows a bottom part 1 of a piston, the bottom part having a large-area joint region 2 on its upper side. The joint region 2 is only interrupted by at least one recess 3. Arranged in this case are altogether four recesses 3 which are located on a circular path. The joint region 2 extends from the outside diameter of the bottom part 1 in the direction of the center region and can be of flat design in the direction of the center axis (piston stroke axis) of the bottom part 1. In the case of the exemplary embodiment according to FIGS. 1A and 1B, a raised portion, which can already be realized along with the production of the bottom part 1, is formed concentrically around the center axis of the bottom part 1 and subsequently can form a part, especially a dome-like raised portion, of a combustion chamber bowl of the finished piston. Furthermore, the bottom part has known per se elements of a piston, such as piston pin bores, piston pin bosses, supporting skirt wall sections and the like. Reference is also to be made to the fact that the design of the bottom part 1, especially in respect to the representation of FIG. 1A, is only by way of example and can also have other designs (such as a continuous cylindrical supporting skirt wall).

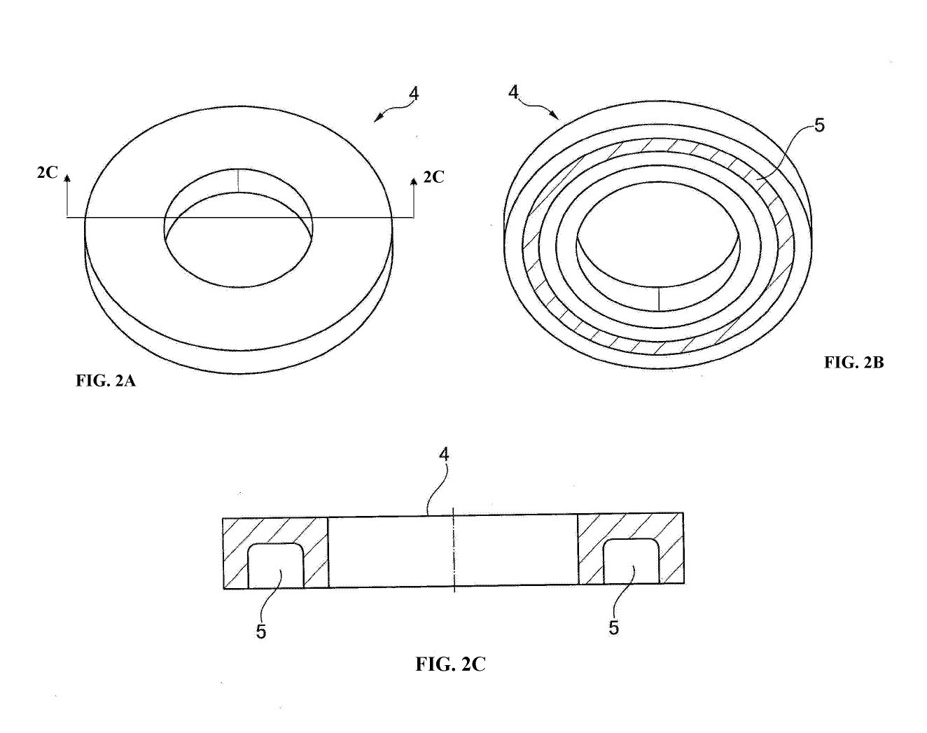

FIGS. 2A-2C show a top part 4, corresponding to the bottom part 1 according to FIGS. 1A-1B, in different views. This top part 4 shown in FIG. 2A has a recess around the center axis (in this case also, the piston stroke axis again) and corresponds to the raised portion of the bottom part 1 according to FIG. 1B so that as a result of this recess a combustion chamber bowl of the piston can subsequently be formed by means of further machining. In the case of the exemplary embodiment according to FIG. 2A, this recess is provided but it does not have to be so. Furthermore, the top part 4 shown in FIG. 2B has an annular recess 5 on its lower side. This annular recess 5 is either already introduced together with production of the top part 4 (e.g. during the casting or forging process or during comparable processes) but can also be introduced subsequently after the actual production of the top part 4 (e.g. by means of a milling process or similar processes).

Suitable processes such as forging, metal cutting processes, eroding and the like may be considered for both the introduction of the at least one recess 3 of the bottom part 1 and of the annular recess 5 of the top part 4. It is important in this case that during the introduction of the annular recess 5 a large degree of freedom exists so that consequently the desired inner contour of a subsequent cooling passage of the finished piston can be established and optimally designed. During the introduction of the at least one recess 3 in the bottom part 1 a large degree of freedom also exists both during the introduction of these recesses and their contouring so that as a result the functioning (passage of the cooling oil jet in the direction of the recess 5) can be achieved, also giving consideration to material savings while maintaining strength at the same time.

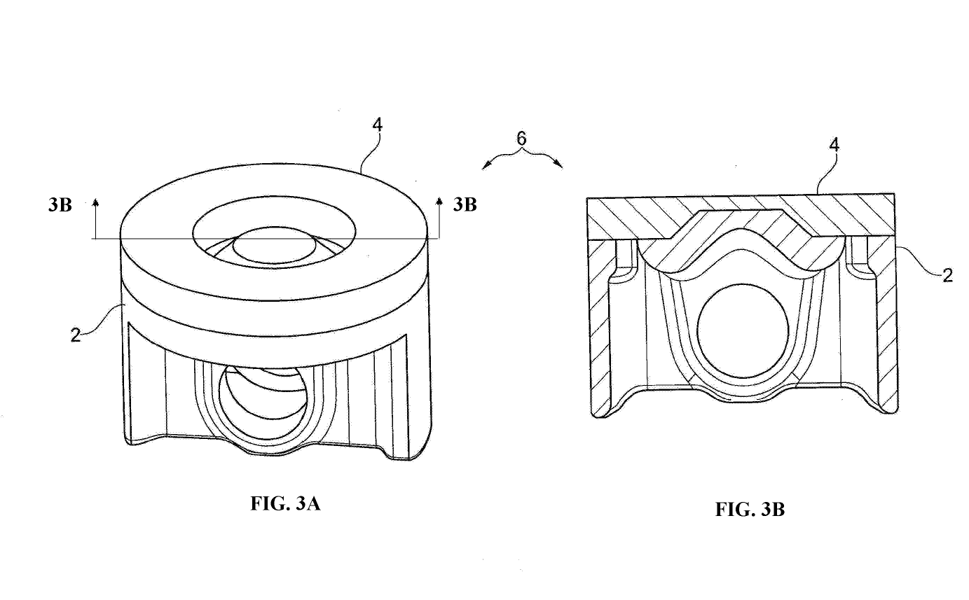

FIGS. 3A and 3B show a finished piston 6 in which the top part 4 is inseparably connected in a materially bonding manner to the bottom part 1, preferably by means of a friction weld joint. It is evident in this case that the at least one recess 3 of the bottom part 1 is in overlapping alignment with the annular recess 5 of the top part 4.

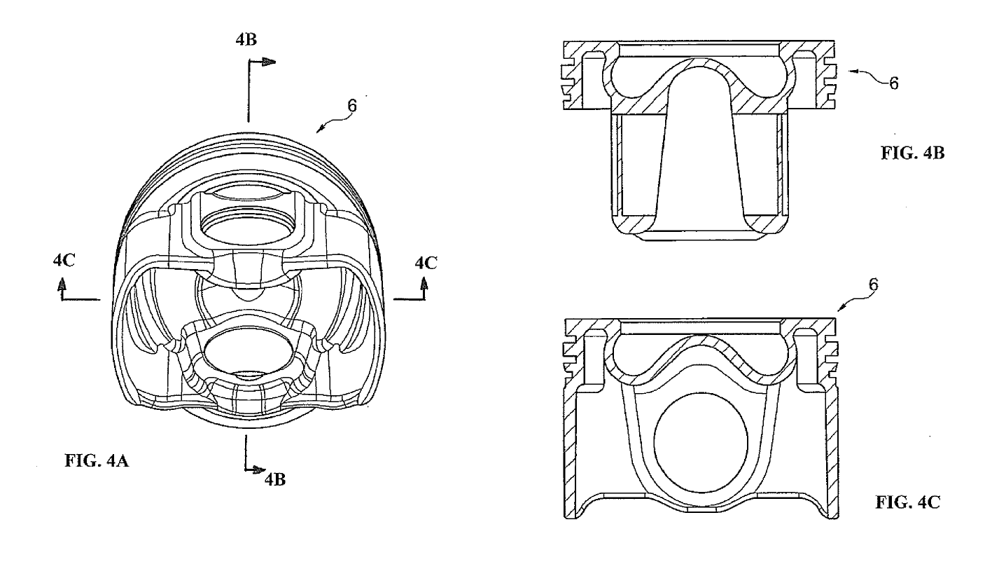

FIGS. 4A-4C show the same piston 6 in different views, in which the bottom part 1 and the top part 4 are inseparably interconnected in a materially bonding manner. It is evident in this case that the material bond is effected by means of a friction weld joint, and friction weld beads in the region of the transition of the annular recess 5 of the top part 4 in the direction of the recess 3 of the bottom part 1 have been retained, i.e. have not been removed. The friction weld beads, which have been created in the direction of the inner region, i.e. in the direction of the combustion chamber bowl, and in the direction of the outer side of the piston 6, i.e. in the direction of the already introduced ring zone, have been removed.

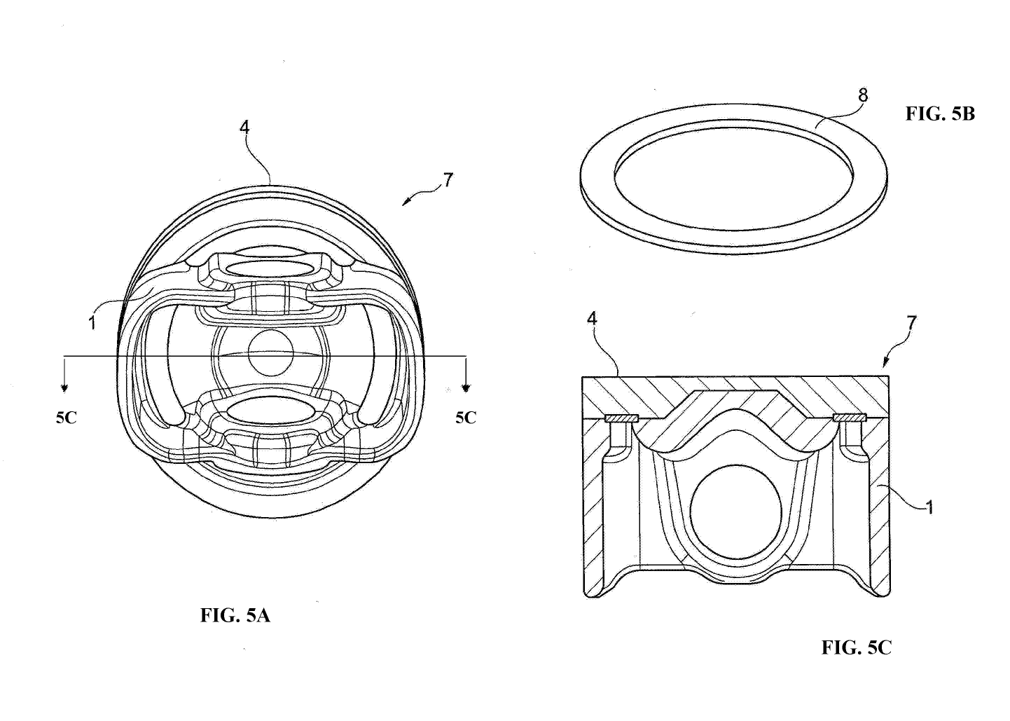

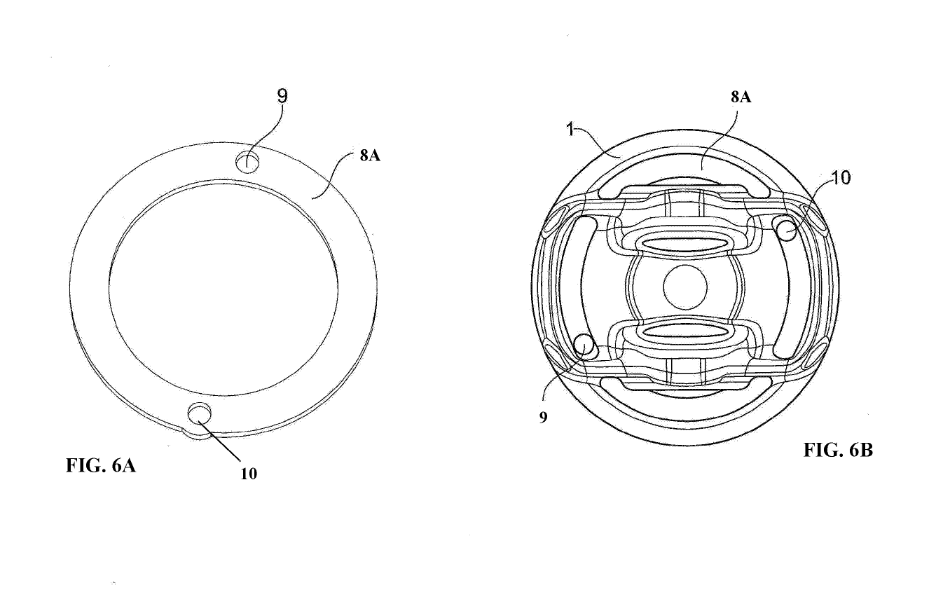

Shown in FIGS. 5A-5C and 6A-6B is an alternative exemplary embodiment of a piston 7 in which use is made of the parts which are already shown in the preceding figures and specified 1, 4. The only difference is to be seen in the fact that a sealing element 8 is produced separately from these parts 1, 4. The sealing element 8, preferably shown here as a one-piece element (wherein multi-piece embodiments are also conceivable), is inserted between the two parts 1, 4 before the materially bonding connecting (see FIG. 5A). After this, the two parts 1, 4 are inseparably interconnected in a materially bonding manner, again preferably by means of a friction weld joint. The arrangement geometries of the one-piece or multi-piece sealing element 8 are adapted to the arrangement geometries of the bottom part 1 and/or of the top part 4 so that a materially bonding connection of the sealing element 8 during the materially bonding connecting of the bottom part 1 to the top part 4 is generally not carried out only on one part 1, or 4, or on both parts 1, 4. The arrangement geometries (such as steps in the edge region of the recesses 3 and/or of the annular recess 5) are advantageously designed so that during the friction weld connection of the bottom part 1 to the top part 4 the sealing element 8 is at least clamped in, though advantageously friction welded as well.

Whereas it is shown in FIGS. 5A and 5C that the annular recess 5 in the top part 4 is completely closed off by the sealing element 8, the sealing element 8 in the form 8A shown in FIG. 6A can be provided with at least one opening 9, preferably two openings one serving as an inlet opening 9 and one opening serving as an outlet opening 10, preferably produced by drilling, along with, or after, its production. As best seen in FIG. 6B, at least one inlet opening 9 and at least one outlet opening 10 are realized so that via the at least one inlet opening 9 a cooling oil jet can be injected into the then mostly closed off cooling passage (closing off of the annular recess 5 by means of the sealing element 8A). Via the other opening serving an outlet opening 10, the medium which is circulating in the cooling passage can then be discharged. This variant is particularly advantageous since the openings 9 and 10 in the sealing element 8A can be made separately from the production of the actual piston so that after insertion of the sealing element 8A between the two parts 1, 4 there is no need for further metal cutting processes for producing the inlet opening 9 and outlet opening 10. In this way, the effect of particles, which are created during the metal cutting process, being present in the cooling medium circuit is effectively avoided. Nevertheless, it is conceivable as an alternative, as is shown in FIG. 5A, to insert a totally continuous sealing element 8 between the two parts 1, 4 and to interconnect these in a materially bonding manner and only then to introduce the at least one opening 9 or 10 for realizing the at least one inlet opening 9 or the at least one outlet opening 10.

For the design of the piston 7 according to FIGS. 5A-5C and 6A-6B, the same also applies as for the design of the piston 6 according to FIGS. 1A to 4C.

According to the invention, provision is made for a piston of an internal combustion engine, formed from a bottom part and a top part, which has a piston crown and a cooling passage, wherein the piston has material recesses which are created by suitable forged contours and joint planes.

The positioning of material recesses is effected by suitable forged contours and joint planes. As a result of this, local material savings can be achieved. By taking into consideration the joint planes in the piston design, appreciable material savings, and consequently a reduction of the piston mass, are achieved. Also, the optimization of the forged contours with regard to material saving leads to an appreciable mass reduction of the piston.

It is furthermore provided according to the invention that the cooling passage has a sealing element.

The piston according to the invention can for example be constructed as a steel piston.

### LIST OF DESIGNATIONS

1 Piston
2 Bottom part
3 Top part
4 Sealing element
5 Annular recess
6 Piston
7 Piston
8 Sealing element
9 Opening
10 Outlet opening

1. A piston of an internal combustion engine, formed from a bottom part and a top part, having a piston crown and a cooling passage, wherein the bottom part is connected to the top part by a materially bonding connection, characterized in that the bottom part has a bottom part flat joint region with at least one recess and the top part has a top part flat joint region and an annular recess which extends from the top part flat joint region into the bottom part, wherein the at least one recess of the bottom part is in overlapping alignment with a section of the top part annular recess after the materially bonding connection.

2. The piston as claimed in claim 1, wherein the bottom part at least one recess comprises more than two recesses.

3. The piston as claimed in claim 1 further comprising a sealing element positioned between the bottom part and the top part.

4. The piston as claimed in claim 3 wherein the sealing element defines at least one opening.

5. The piston as claimed in claim 1 wherein the materially bonding connection comprises a friction weld joint.

6. The piston of claim 2 wherein the more than two recesses comprises four recesses.

7. The piston as claimed in claim 2 further comprising a sealing element positioned between the bottom part and the top part.

8. An internal combustion engine piston comprising:
a bottom part having a planar joining region defining at least one recess;
a top part having a top surface and a bottom surface opposite the bottom part planar joining region, the top part defining a through annular recess, the bottom surface having a planar joining region radially aligned with a portion of the bottom part planar joining region, the top part bottom surface further defining a radial recess axially extending toward the top surface, wherein on permanent attachment of the top part to the bottom part, the top part radial recess is positioned in radial and angular alignment with a portion of the bottom part at least one recess forming a coolant channel.

9. The piston of claim 8 wherein the at least one recess in the bottom part comprises four recesses angularly spaced from one another.

10. The piston of claim 9 further comprising a sealing element positioned between the top part and the bottom part, the sealing element radially and angularly aligned to cover a portion of the bottom part four recesses.

11. The piston of claim 9 wherein the sealing element completely covers the bottom part four recesses preventing passage of a coolant from the bottom part to the top part radial recess.

12. The piston of claim 10 wherein the sealing element further defines a coolant inlet aperture operable to allow a coolant to be injected through the coolant inlet aperture into the top part radial recess.

13. The piston of claim 12 wherein the sealing element further defines a coolant outlet aperture angularly spaced from the coolant inlet aperture, the coolant outlet aperture operable to allow the coolant in the top part radial recess to exit the top part radial recess.
